(19) United States
(12) Patent Application Publication
(10) Pub. No.: US 2015/0118897 A1
(43) Pub. Date: Apr. 30, 2015

(54) COAXIAL CABLE AND CONNECTOR WITH CAPACITIVE COUPLING

(71) Applicant: Andrew LLC, Hickory, NC (US)

(72) Inventors: Jeffrey D. Paynter, Momence, IL (US); Frank Harwath, Naperville, IL (US)

(21) Appl. No.: 14/102,042

(22) Filed: Dec. 10, 2013

Related U.S. Application Data
(60) Provisional application No. 61/895,113, filed on Oct. 24, 2013.

(51) Int. Cl. H01R 24/54

(52) U.S. Cl. CPC H01R 24/54
USPC 439/578

(57) ABSTRACT

A coaxial connector junction includes first and second coaxial connectors. The first coaxial connector engages the second coaxial connector, the post of the first central conductor extension being inserted into the cavity of the second central conductor extension such that a capacitive element is created between the first and second central conductor extensions by a gap between the first central conductor extension and the second central conductor extension.

### RELATED APPLICATION

The present application claims the benefit of and priority from U.S. Provisional Patent Application No. 61/895,113, filed Oct. 24, 2013, the disclosure of which is hereby incorporated herein in its entirety.

### FIELD OF THE INVENTION

The present invention is directed generally to electrical cable connectors, and more particularly to coaxial connectors for electrical cable.

### BACKGROUND OF THE INVENTION

Coaxial cables are commonly utilized in RF communications systems. A typical coaxial cable includes an inner conductor, an outer conductor, a dielectric layer that separates the inner and outer conductors, and a jacket that covers the outer conductor. Coaxial cable connectors may be applied to terminate coaxial cables, for example, in communication systems requiring a high level of precision and reliability.

Coaxial connector interfaces provide a connect/disconnect functionality between (a) a cable terminated with a connector bearing the desired connector interface and (b) a corresponding connector with a mating connector interface mounted on an apparatus or on another cable. Typically, one connector will include a structure such as a pin or post connected to an inner conductor and an outer conductor connector body connected to the outer conductor; these are mated with a mating sleeve (for the pin or post of the inner conductor) and another outer conductor connector body of a second connector. Coaxial connector interfaces often utilize a threaded coupling nut or other retainer that draws the connector interface pair into secure electro-mechanical engagement when the coupling nut (which is captured by one of the connectors) is threaded onto the other connector.

Passive Intermodulation Distortion (PIM) is a form of electrical interference/signal transmission degradation that may occur with less than symmetrical interconnections and/or as electro-mechanical interconnections shift or degrade over time. Interconnections may shift due to mechanical stress, vibration, thermal cycling, and/or material degradation. PIM can be an important interconnection quality characteristic, as PIM generated by a single low quality interconnection may degrade the electrical performance of an entire RF system. Thus, the reduction of PIM via connector design is typically desirable.

### SUMMARY

As a first aspect, embodiments of the invention are directed to a coaxial connector junction comprising first and second coaxial connectors. The first coaxial connector comprises: a first central conductor extension comprising a substantially cylindrical post; a first outer conductor extension spaced apart from and circumferentially surrounding the first central conductor extension; and a first dielectric spacer interposed between the first central conductor extension and the first outer conductor extension. The second coaxial connector comprises: a second central conductor extension, the second central conductor extension including a substantially cylindrical cavity therein; a second outer conductor extension spaced apart from and circumferentially surrounding the second central conductor extension; and a second dielectric spacer interposed between the second central conductor extension and the second outer conductor extension. The first coaxial connector engages the second coaxial connector, the post of the first central conductor extension being inserted into the cavity of the second central conductor extension such that a capacitive element is created between the first and second central conductor extensions by a gap between the first central conductor extension and the second central conductor extension.

As a second aspect, embodiments of the invention are directed to a coaxial connector junction, comprising a first coaxial connector and a second coaxial connector. The first coaxial connector comprises: a first central conductor extension comprising a post, the post at least partially covered by a first dielectric layer comprising a shrink sleeve; a first outer conductor extension spaced apart from and circumferentially surrounding the first central conductor extension; and a first dielectric spacer interposed between the first central conductor extension and the first outer conductor extension. The second coaxial connector comprises: a second central conductor extension, the second central conductor extension including a cavity therein; a second outer conductor extension spaced apart from and circumferentially surrounding the second central conductor extension; and a second dielectric spacer interposed between the second central conductor extension and the second outer conductor extension. The first coaxial connector engages the second coaxial connector, the post of the first central conductor extension being inserted into the cavity of the second central conductor extension such that a capacitive element is created between the first and second central conductor extensions.

As a third aspect, embodiments of the invention are directed to a coaxial connector junction comprising a first coaxial connector and a second coaxial connector. The first coaxial connector comprises: a first central conductor extension; a dielectric element attached to the first central conductor extension, the dielectric element having a flat contact surface; a first outer conductor extension spaced apart from and circumferentially surrounding the first central conductor extension; and a first dielectric spacer interposed between the first central conductor extension and the first outer conductor extension. The second coaxial connector comprises: a second central conductor extension having a flat contact surface; a second outer conductor extension spaced apart from and circumferentially surrounding the second central conductor extension; and a second dielectric spacer interposed between the second central conductor extension and the second outer conductor extension. The first coaxial connector engages the second coaxial connector, the contact surface of the second central conductor extension abutting the contact surface of the dielectric element attached to the first central conductor extension such that a first capacitive element is created between the first and second central conductor extensions.

### BRIEF DESCRIPTION OF THE FIGURES

FIG. 1 is a partial cross-section of the coaxial cable-connector assembly according to embodiments of the invention, the assembly being shown in a mated condition.

FIG. 2 is a partial cross-section of the coaxial cable-connector assembly of FIG. 1 shown in an unmated condition.

FIG. 3 is an enlarged partial section of the coaxial cable-connector assembly of FIG. 1.

FIG. 4 is an enlarged partial section of the coaxial cable-connector assembly of FIG. 1.

FIG. 5 is an enlarged partial section of the coaxial cable-connector assembly of FIG. 1.

FIG. 6 is an enlarged partial section of the coaxial cable-connector assembly of FIG. 2.

FIG. 7 is an enlarged partial section of the coaxial cable-connector assembly of FIG. 1.

FIG. 8 is a partial cross-section of a coaxial cable-connector assembly according to additional embodiments of the invention, with the assembly shown in a mated condition.

FIG. 9 is a partial cross-section of the coaxial cable-connector assembly of FIG. 8 shown in an unmated condition.

FIG. 10 is an enlarged partial section of the coaxial cable-connector assembly of FIG. 8.

FIG. 11 is an enlarged partial section of the coaxial cable-connector assembly of FIG. 8.

### DETAILED DESCRIPTION OF EMBODIMENTS OF THE INVENTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the above description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

FIGS. 1 and 2 illustrate two coaxial cables, designated broadly at 10 and 110, according to embodiments of the present invention. The cable 10 includes a central conductor 12, a dielectric layer 14 that circumferentially overlies the central conductor 12, an outer conductor 16 that circumferentially overlies the dielectric layer 14, and a polymeric cable jacket 20 that circumferentially overlies the outer conductor 16. Similarly, the cable 110 includes a central conductor 112, a dielectric layer 114 that circumferentially overlies the central conductor 112, an outer conductor 116 that circumferentially overlies the dielectric layer 114, and a polymeric cable jacket 120 that circumferentially overlies the outer conductor 116. These components will be well-known to those of skill in this art and need not be described in detail herein. FIGS. 1 and 2 illustrate that the outer conductors 16, 116 may be of a corrugated profile; alternatively, the outer conductors 16, 116 may not have a corrugated profile. Both of these outer conductor configurations are known to those of skill in this art and need not be described in detail herein.

Referring again to FIGS. 1 and 2, the cable 10 includes a plug 30 that enables the cable 10 to be connected with a jack 130 of the mating coaxial cable 110 (those skilled in this art will recognize that, in some instances, it may be unclear which of two mating connectors is the “plug” and which is the “jack”. The terms are largely interchangeable as used herein, as each is intended to refer to a coaxial connector that mates with another mating coaxial cable connector). FIG. 1 shows the plug 30 and jack 130 in their mated condition; FIG. 2 shows the plug 30 and jack 130 in a largely unmated condition as the jack 130 is being inserted into the plug 30.

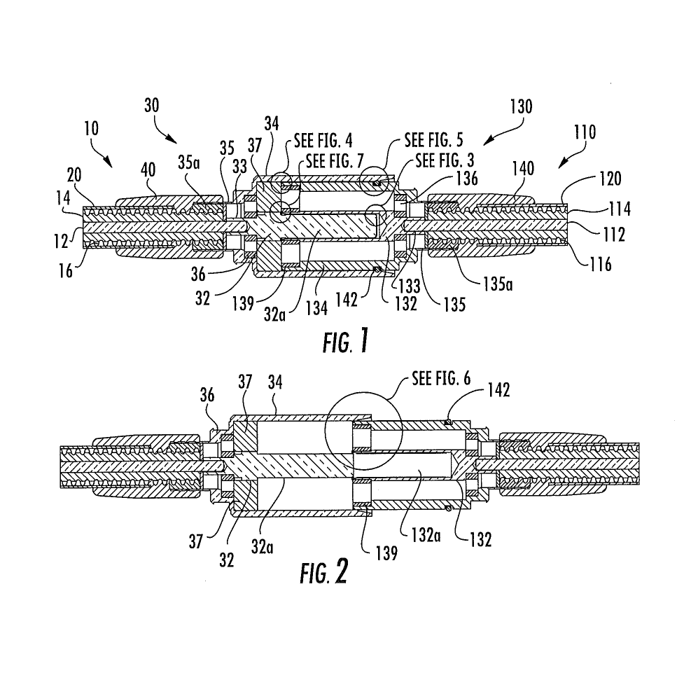

The plug 30 includes a central conductor extension 32, an outer conductor extension 34 and an overmold body 40. The central conductor extension 32 has a generally cylindrical post 32a and is mounted on and is in electrical contact with the central conductor 12 of the cable 10 via a boss 33. As can be seen in FIG. 3, the post 32a has rounded edges at its free end. The outer conductor extension 34 is mounted in electrical contact with the outer conductor 16 of the conductor 10 via a tail 35 that is soldered to the outer conductor 16 at a solder joint 35a. The free end 34a of the outer conductor 34 is bevelled to facilitate insertion of the jack 130 (see FIG. 5). An annular dielectric spacer 36 is positioned between the central conductor extension 32 and the outer conductor extension 34 near the junction between the central conductor 12 and the central conductor extension 32. Another annular dielectric spacer 37 abuts the spacer 36 and maintains separation between the central conductor extension 32 and the outer conductor extension 34. The spacers 36, 37 position the outer conductor extension 34 to be spaced apart from and to circumferentially surround the central conductor extension 32. The central conductor extension 32 includes an annular recess 32b radially inwardly of the spacer 36 (see FIG. 7). The overmold body 40 surrounds the end of the cable 10 and the portion of the tail 35 that is soldered to the outer conductor 16.

As can be seen in FIG. 3, the post 32a of the central conductor extension 32 underlies a dielectric layer 44. In the illustrated embodiment, the dielectric layer 44 is formed of a polymeric shrink sleeve; in one example, the shrink sleeve may be formed of polyester or PTFE. The dielectric layer 44 is typically between about 0.001 and 0.003 inches in thickness. As can be seen in FIG. 7, the end portion of the sleeve comprising the dielectric layer 44 shrinks into the recess 32b, which helps to fix the dielectric layer 44 in place.

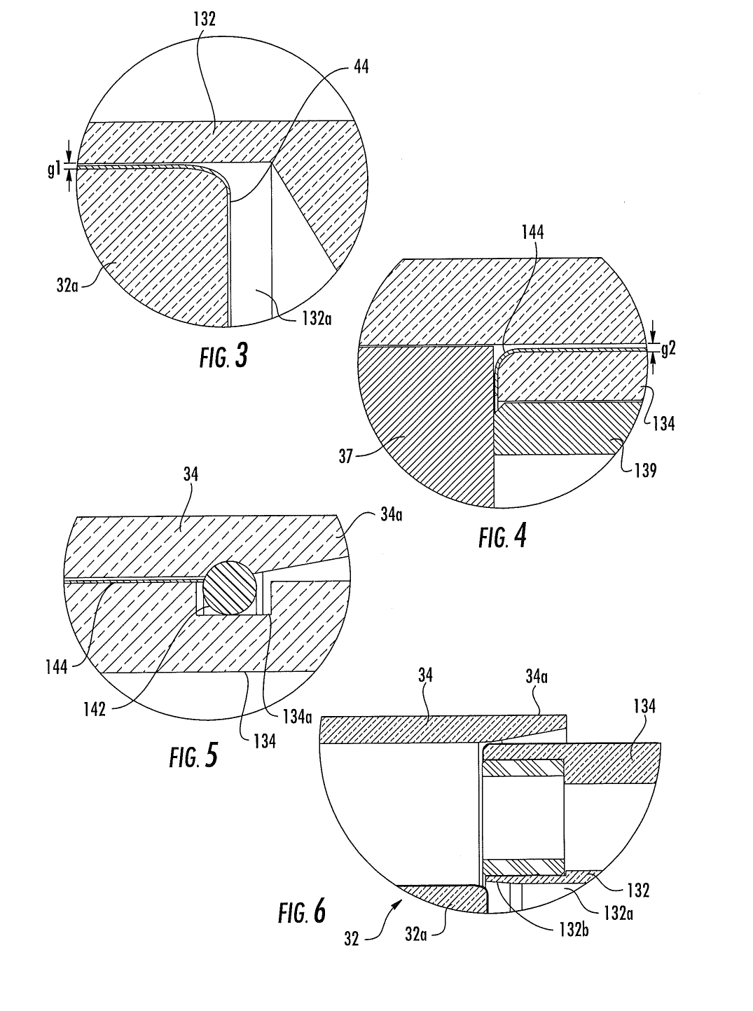

Referring again to FIGS. 1 and 2, the jack 130 includes a central conductor extension 132, an outer conductor extension 134, and an overmold body 140. The central conductor extension 132 is mounted on and is in electrical contact with the central conductor 112 of the cable 110 via a boss 133. The central conductor extension 132 is hollow at its free end, forming a cavity 132a with a bevelled end 132b (see FIGS. 2 and 6). The outer conductor extension 134 is mounted in electrical contact with the outer conductor 116 of the conductor 110 via a tail 135 that is soldered to the outer conductor 116 at a solder joint 135a. As can be seen in FIG. 4, the outer conductor extension 134 has a rounded edge at its free end. An annular dielectric spacer 136 is positioned between the central conductor extension 132 and the outer conductor extension 134 near the junction between the central conductor 112 and the central conductor extension 132. Another annular dielectric spacer 139 is located at the free ends of the central conductor extension 132 and the outer conductor extension 134 and maintains separation between the central conductor extension 132 and the outer conductor extension 134. The spacers 136, 139 position the outer conductor extension 134 to be spaced apart from and circumferentially surround the central conductor extension 132. The overmold body 140 surrounds the end of the cable 110 and the portion of the tail 135 that is soldered to the outer conductor 116. Also, an O-ring 142 is located within an annular recess 134a in the outer conductor extension 134 (see FIG. 5).

A dielectric layer 144 overlies the outer conductor extension 134 (see FIGS. 4 and 5). Like the dielectric layer 44, in the illustrated embodiment, the dielectric layer 144 is formed of a polymeric shrink sleeve; in one example, the shrink sleeve may be formed of polyester or PTFE. The dielectric layer 144 is typically between about 0.001 and 0.003 inches in thickness. As can be seen in FIG. 5, the end portion of the sleeve comprising the dielectric layer 144 shrinks into the recess 134a, which helps to fix the dielectric layer 144 in place.

As shown in FIG. 1, the central conductor extension 32 and the outer conductor extension 34 of the plug 30 are configured to mate with the central conductor extension 132 and the outer conductor extension 134 of the jack 130. More specifically, the post 32a of the central conductor extension 32 of the plug 30 fits within the cavity 132a of the central conductor extension 132 of the jack 130, while the outer conductor extension 134 of the jack 130 fits within the walls of the partially overlying outer conductor extension 34 of the plug 30. The O-ring 142 is compressed radially inwardly by the outer conductor extension 34, thereby forming a watertight seal between the plug 30 and jack 130 (see FIG. 5).

FIG. 3 illustrates that, when the plug 30 and jack 130 are mated, a gap g1 is formed between the outer surface of the post 32a and the inner surface of the central conductor extension 132. In the illustrated embodiment, both the dielectric layer 44 and an air space are present in the gap g1, although in some embodiments the dielectric layer 44 fills the gap g1 entirely, and in other embodiments the gap g1 may have no explicit dielectric layer 44. The presence of the dielectric layer 44 and/or the air space electrically insulates the central conductor extension 32 of the plug 30 from the central conductor extension 132 of the jack 130, thereby forming a capacitive element between these components (see FIG. 3). The capacitive element so created can avoid the generation of PIM that can occur in interconnecting coaxial cables.

Similarly, and as can be seen in FIG. 4, a gap g2 is formed between the outer surface of the outer conductor extension 134 of the jack 130 and the inner surface of the outer conductor extension 34 of the plug 30. In the illustrated embodiment, both the dielectric layer 144 and an air space are present in the gap g2, although in some embodiments the dielectric layer 144 fills the gap g2 entirely, and in other embodiments the gap g2 may have no explicit dielectric layer 144. The presence of the dielectric layer 144 and/or the air space electrically insulates the outer conductor extension 134 of the jack 130 from the outer conductor extension 34 of the plug 30, thereby forming a capacitive element between these components that can avoid the generation of PIM.

The central elements when mated form a resonant cavity, which allows the mated plug 30 and jack 130 to be “tuned” to operate beneficially and/or optimally at particular frequencies. This can be achieved by selecting a combination of cavity length, type of dielectric material, thickness of dielectric material, and/or thickness of the air space to provide a desired capacitance. Typically minimizing the air space can provide a broadband improvement in reflection by reducing the distance between the conductors, thus increasing the capacitance. Air gaps may be used when necessary or desirable to allow for ease of insertion given tolerances of the assembled parts.

In some embodiments, air space in the gap g1 and/or the gap g2 can provide a dampening effect during mating of the plug 30 and the jack 130. For example, if the air space in the gap g2 is between about 0.05 and 0.15 mm, air flow from the cavity of the plug 30 upon insertion of the jack 130 is sufficiently restricted that, as insertion proceeds, an air “cushion” is formed. In some prior connectors, and in particular blind-mated connectors (such as blind mated interfaces associated with heavy antenna/radio-head, etc.) there is a danger of the interfaces slamming together and damaging connector parts, brackets, fasteners and the like. With a restricted air flow that creates a built-in air cushion, time is required to allow the air to leak out of the interface. This can produce a “soft” mating, which can eliminate the danger associated with components slamming together.

As can be seen in FIG. 6, the rounded outer edge of the free end of the outer conductor extension 134 of the jack 130 can facilitate insertion of the outer conductor extension 134 within the outer conductor extension 34 of the plug 30. Insertion is also aided by the slight beveling in the free end 34a of the outer conductor extension 34 of the plug 30 (see again FIG. 6). In a similar manner, and as shown in FIG. 3, the rounded edge of the free end of the post 32a of the central conductor extension 32 of the plug 30 can facilitate insertion of the central conductor extension 32 within the cavity 132a of the central conductor extension 132 of the jack 130.

Notably, and as can be seen in FIGS. 2 and 6, the outer conductor extension 34 extends farther away from the cable 10 (and deeper into the jack 130) than does the central conductor extension 32, such that, when the plug 30 and jack 130 are brought together to mate as in FIGS. 2 and 6, the outer conductor extension 134 of the jack 130 contacts and engages the outer conductor extension 34 prior to engagement of the central conductor extensions 32, 132. The bevelled end 34a of the outer conductor extension 34 tends to “center” the jack 130 relative to the plug 30, thereby facilitating engagement and mating of the central conductor extensions 32, 132. Engagement of the central conductor extensions 32, 132 is also facilitated by the beveling of the end 132b of the central conductor extension 132 (see FIG. 6).

As shown in FIGS. 1 and 4, mating of the plug 30 and jack 130 is complete when the jack 130 “bottoms out” against the plug 30, which occurs when the spacer 139 of the jack 130 contacts the spacer 37 of the plug 30. As can be seen in FIG. 7, the spacer 139 extends slightly farther away from the cable 110 (and deeper into the plug 130) than does the central conductor extension 132, such that the central conductor extension 132 is prevented from contact and electrical connection with the central conductor 32, thereby preserving the capacitively coupled electrical connection created by the dielectric layer 44.

In addition to the materials discussed above, exemplary materials for the dielectric layers 44, 144 include other polymeric materials, ceramic materials, and glass. The dielectric strength of the materials of the dielectric layers 44, 144 is typically above about 8 MV/m. Although application as a shrink sleeve is illustrated and described herein, the dielectric layers 44, 144 may be applied in a number of different ways, including painting, spraying, sputter coating, or the like. In some embodiments, the capacitive element is sized and arranged so that it creates capacitance on the order of 10-50 pico farads between the conductor extensions 32, 34 of the plug 30 and the respective conductor extensions 132, 134 of the jack 130.

Although the plug 30 and jack 130 are illustrated herein attached to free coaxial cables 10, 110, in some embodiments one of these connectors may be mounted within a structure, such as a shoulder plate such as that described in co-pending and co-assigned U.S. Patent Publication No. 2013/0065415, the disclosure of which is hereby incorporated herein by reference, that presents multiple connectors at once. Such a shoulder plate or similar mounting structure may be mounted on an antenna, remote radio head or the like.

Referring now to FIGS. 8-11, another coaxial cable-connector assembly, designated broadly at 200, is shown therein. The assembly 200 includes a plug 230 and a jack 330; the plug 230 is attached to a coaxial cable 210 of similar construction to that described above, and the jack 330 is attached to a coaxial cable 310, also of similar construction. The plug 230 and the jack 330 are described below.

The plug 230 includes an outer conductor extension 234 similar in configuration to the outer conductor extension 34 of the plug 30. The plug 230 further includes a central conductor extension 232 with a boss 233 that fits over the central conductor 212 of the cable 210. A body 235 is attached to the boss 233. A dielectric spacer 237 is positioned between the body 235 and the outer conductor extension 234. A circular flange 236 extends from the free end of the body 235 opposite the boss 233.

A dielectric disk 244 with a flat contact surface is mounted on the flange 236. The dielectric disk 244 may be formed of any number of dielectric materials. In some embodiments, the dielectric disk may be formed of polyester, PTFE, ceramic, glass or the like. Typically, the dielectric disk 244 is between about 0.001 and 0.003 inches in thickness (the thickness of the dielectric disk 244 is greatly exaggerated in FIGS. 8 and 9 for illustrative purposes).

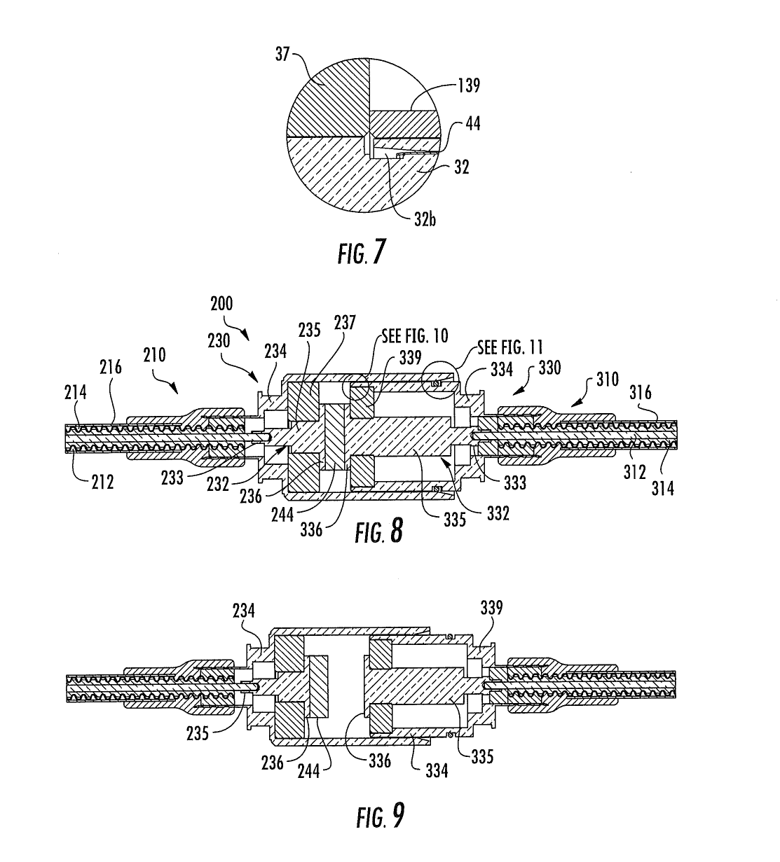

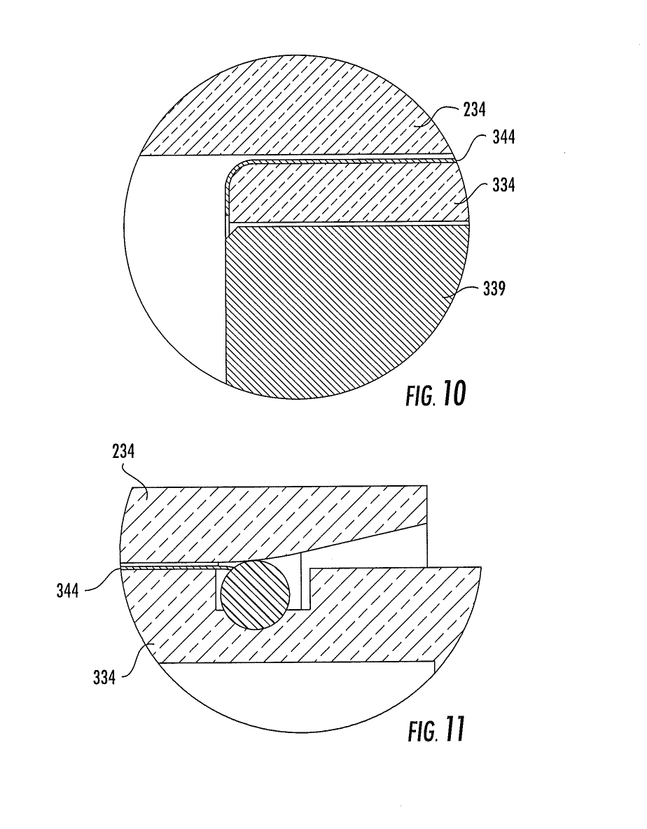

The jack 330 includes an outer conductor extension 334 that is similar to the outer conductor extension 134 of the jack 130 described above. The outer conductor extension 334 is covered with a dielectric layer 344 similar to the dielectric layer 144 described above (FIGS. 10 and 11). A central conductor extension 332 is attached at one end to the central conductor 312 of the cable 310 via a boss 333. The central conductor extension 332 includes a solid body 335 that extends away from the boss 333. A circular flange 336 with a flat contact surface extends from the free end of the body 335 that is opposite the boss 333. The flange 336 is sized to be similar in diameter to the flange 236 of the plug 230. A dielectric spacer 339 is positioned between the body 335 of the central conductor extension 332 and the outer conductor extension 334 so that it abuts the underside of the flange 336.

As can be seen in FIGS. 8 and 9, the plug 230 and jack 330 can be mated by inserting the outer conductor extension 334 of the jack 330 within the outer conductor extension 234 of the plug 230. Insertion proceeds until the contact surface of the flange 336 of the jack 330 contacts the contact surface of the dielectric disk 244 of the plug 230. At this point the outer conductor extension 234 of the plug 230 is electrically insulated from the outer conductor extension 334 of the jack 330, and the flange 236 of the plug 230 is electrically insulated from the flange 336 of the jack 330, thereby creating capacitive coupling that can minimize or prevent PIM.

Those skilled in this art will appreciate that the plug 230 and jack 330 may take different forms. For example, the central conductor extensions 232, 242 need not have flanges 236, 336 that extend radially outwardly from their respective bodies 235, 335, but instead may present contact surfaces that are the same size or even narrower than the bodies 235, 335. The dielectric disk 244 may be a dielectric elements of another configuration. Also, the dielectric disk 244 may be attached to the central conductor extension 332 of the jack 330 rather than to the central conductor extension 232 of the plug 230. Other variations may also be employed.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A coaxial connector junction, comprising:
(a) a first coaxial connector, comprising:
a first central conductor extension comprising a substantially cylindrical post;
a first outer conductor extension spaced apart from and circumferentially surrounding the first central conductor extension; and
a first dielectric spacer interposed between the first central conductor extension and the first outer conductor extension;
(b) a second coaxial connector, comprising:
a second central conductor extension, the second central conductor extension including a substantially cylindrical cavity therein;
a second outer conductor extension spaced apart from and circumferentially surrounding the second central conductor extension; and
a second dielectric spacer interposed between the second central conductor extension and the second outer conductor extension;
wherein the first coaxial connector engages the second coaxial connector, the post of the first central conductor extension being inserted into the cavity of the second central conductor extension such that a capacitive element is created between the first and second central conductor extensions by a gap between the first central conductor extension and the second central conductor extension.

2. The coaxial connector junction defined in claim 1, wherein a first dielectric layer is interposed between the post of the first central conductor extension and the second central conductor extension.

3. The coaxial connector junction defined in claim 2, wherein the first dielectric layer overlies the first central conductor extension.

4. The coaxial connector junction defined in claim 3, wherein the first dielectric layer comprises a shrink sleeve applied over the post of the first central conductor extension.

5. The coaxial connector junction defined in claim 1, wherein a capacitive element is formed between the first outer conductor extension and the second outer conductor extension by a gap therebetween.

6. The coaxial connector junction defined in claim 5, further comprising a second dielectric layer interposed between the first outer conductor extension and the second outer conductor extension.

7. The coaxial connector junction defined in claim 1, wherein the first outer conductor extension at least partially overlies the second outer conductor extension.

8. The coaxial connector junction defined in claim 1, further comprising a coaxial cable attached to one of the first or second coaxial connectors.

9. The coaxial connector junction defined in claim 1, wherein the first and second outer conductor extensions and the first and second central conductors are configured such that, when the first and second connectors are brought into engagement, the first and second outer conductor extensions engage each other before the first and second central conductor extensions.

10. The coaxial connector junction defined in claim 1, wherein the second dielectric spacer extends deeper into the first connector than the second central conductor extension and the second outer conductor extension.

11. The coaxial connector junction defined in claim 1, wherein the first outer conductor extension extends deeper into the second connector than the first central conductor extension.

12. The coaxial connector junction defined in claim 1, wherein the first outer conductor extension has a flared edge.

13. The coaxial connector junction defined in claim 1, wherein the second inner conductor extension has a flared edge.

14. The coaxial connector junction defined in claim 1, wherein the first dielectric spacer is in contact with the second dielectric spacer.

15. The coaxial connection junction defined in claim 1, wherein one of the first and second coaxial connectors is mounted in a mounting structure.

16. A coaxial connector junction, comprising:
(a) a first coaxial connector, comprising:
a first central conductor extension comprising a post, the post at least partially covered by a first dielectric layer comprising a shrink sleeve;
a first outer conductor extension spaced apart from and circumferentially surrounding the first central conductor extension; and
a first dielectric spacer interposed between the first central conductor extension and the first outer conductor extension;
(b) a second coaxial connector, comprising:
a second central conductor extension, the second central conductor extension including a cavity therein;
a second outer conductor extension spaced apart from and circumferentially surrounding the second central conductor extension; and
a second dielectric spacer interposed between the second central conductor extension and the second outer conductor extension;
wherein the first coaxial connector engages the second coaxial connector, the post of the first central conductor extension being inserted into the cavity of the second central conductor extension such that a capacitive element is created between the first and second central conductor extensions.

17. A coaxial connector junction, comprising:
(a) a first coaxial connector, comprising:
a first central conductor extension;
a dielectric element attached to the first central conductor extension, the dielectric element having a flat contact surface;
a first outer conductor extension spaced apart from and circumferentially surrounding the first central conductor extension; and
a first dielectric spacer interposed between the first central conductor extension and the first outer conductor extension;
(b) a second coaxial connector, comprising:
a second central conductor extension having a flat contact surface;
a second outer conductor extension spaced apart from and circumferentially surrounding the second central conductor extension; and
a second dielectric spacer interposed between the second central conductor extension and the second outer conductor extension;
wherein the first coaxial connector engages the second coaxial connector, the contact surface of the second central conductor extension abutting the contact surface of the dielectric element attached to the first central conductor extension such that a first capacitive element is created between the first and second central conductor extensions.

18. The coaxial connector junction defined in claim 17, wherein a second capacitive element is formed between the first outer conductor extension and the second outer conductor extension by a gap therebetween.

19. The coaxial connector junction defined in claim 17, wherein the first central conductor extension includes a body and a flange, the second central conductor extension includes a body and a flange, the dielectric element comprises a disk attached to the flange of the first central conductor extension, and the contact surface of the second central conductor extension is located on the flange of the second central conductor extension.

20. The coaxial connector junction defined in claim 17, further comprising a coaxial cable attached to one of the first or second coaxial connectors.
